(19) United States
(12) Patent Application Publication
(10) Pub. No.: US 2026/0142295 A1
(43) Pub. Date: May 21, 2026

(54) BATTERY SYSTEM WITH INLAY ELEMENT PROVIDING MULTIPLE-SEALING

(71) Applicant: SAMSUNG SDI CO., LTD., Yongin-si (KR)

(72) Inventor: Manuel BAUER, Tillmitsch (AT)

(21) Appl. No.: 19/323,651

(22) Filed: Sep. 9, 2025

(30) Foreign Application Priority Data
Nov. 15, 2024 (EP) 24213361.9

(51) Int. Cl. H01M 50/24; H01M 50/204; H01M 50/249; H01M 50/264; H01M 50/271

(52) U.S. Cl. CPC H01M 50/24; H01M 50/204; H01M 50/249; H01M 50/264; H01M 50/271

(57) ABSTRACT

A battery system includes: a battery housing including a frame and a cover plate forming an accommodation chamber therebetween; a plurality of battery cells in the accommodation chamber; and an inlay element including a sleeve portion having a through-hole extending therethrough and a collar portion at one end of the sleeve portion. A tunnel extends through the frame to receive a fastener extending to fasten the battery system to a vehicle. The sleeve portion extends into the tunnel of the frame and the collar portion is outside of the tunnel abutting a surface of the cover plate. The sleeve portion has a sleeve seal sealing the sleeve portion to an inner surface of the tunnel, and the collar portion has a first collar seal abutting the surface of the cover plate sealing the collar portion to the cover plate.

### CROSS-REFERENCE-TO RELATED APPLICATION

The present application claims priority to and the benefit of European Patent Application No. 24213361.9, filed on Nov. 15, 2024, in the European Patent Office, the entire disclosure of which is incorporated herein by reference.

### BACKGROUND

### 1. Field of the Disclosure

Aspects of embodiments of the present disclosure relate to a battery system with an inlay element providing multiple-sealing.

### 2. Technological Background

Recently, vehicles for transportation of goods and people have been developed that use electric power as a source for motion. Such an electric vehicle is an automobile that is propelled, permanently or temporarily, by an electric motor using energy stored in rechargeable (or secondary) batteries. An electric vehicle may be solely powered by batteries (a so-called Battery Electric Vehicle or BEV) or may include a combination of an electric motor and, for example, a conventional combustion engine (a so-called Plugin Hybrid Electric Vehicle or PHEV). BEVs and PHEVs use high-capacity rechargeable batteries, which are designed to provide power for propulsion for sustained periods of time.

Generally, a rechargeable (or secondary) battery cell includes an electrode assembly including a positive electrode, a negative electrode, and a separator interposed between the electrodes. A solid or liquid electrolyte allows for the movement of ions during charging and discharging of the battery cell. The electrode assembly is located in (or is accommodated in) a casing (or a case) and electrode terminals, which are positioned on the outside of the casing, establish an electrically conductive connection to the electrodes. The shape of the casing may be, for example, cylindrical or rectangular.

A battery module includes a plurality of battery cells connected together in series and/or in parallel. That is, the battery module is formed by interconnecting electrode terminals of the plurality of battery cells to each other, with the number of battery cells and connection configuration depending on a desired amount of power, and to provide a relatively high-power rechargeable battery.

Battery modules can have either a block design or a modular design. In the block design, each battery cell is coupled to a common current collector structure and a common battery management system, and the unit thereof is accommodated in a housing. In the modular design, pluralities of battery cells are connected together to form submodules, and several submodules are connected together to form the battery module. In automotive applications, battery systems may include a plurality of battery modules connected together in series to provide a desired voltage.

A battery pack is a set of any number of (usually identical) battery modules or individual battery cells. The battery modules or, respectively, the battery cells, may be connected in a series, parallel, or series/parallel configuration to provide the desired voltage, capacity, and/or power density. Components of a battery pack include the individual battery modules and interconnects, which provide electrical conductivity between the battery modules.

Mechanical integration of a battery pack is achieved by suitable mechanical connections between the individual components, for example, between the battery modules and between the battery modules and a supporting structure of, for example, the vehicle. These connections should remain functional and safe throughout the average service life of the battery system. Further, installation space and interchangeability specifications should be met, especially in mobile applications.

Mechanical integration of battery modules may be achieved by providing a carrier framework and by positioning the battery modules thereon. Fixing the battery cells or battery modules may be achieved by fitted depressions in the framework or by mechanical interconnectors, such as bolts or screws. In other examples, the battery modules are confined by fastening side plates to lateral sides of the carrier framework. In some applications, cover plates may be fixed atop and below the battery modules.

The carrier framework of the battery pack is mounted to a carrying structure of, for example, the vehicle. When the battery pack is to be fixed at a bottom of the vehicle, the mechanical connection may be established from the bottom side by, for example, bolts passing through the carrier framework of the battery pack. The framework is usually made of aluminum or an aluminum alloy to lower the total weight of the construction.

A conventional battery system, despite any modular structure, usually includes a battery housing that acts as an enclosure to seal the battery system from the environment and to provide structural protection of the battery system's components. Housed battery systems are usually mounted as a whole into their application environment, for example, to an electric vehicle. Thus, replacement of defective or damaged system parts, for example, a defective battery submodule, requires dismounting the entire battery system and removal of its housing. Even defects of small and/or cheap system parts may require the dismounting and separate repair of the entire battery system or replacement of the entire battery system. Because high-capacity battery systems are expensive, large, and heavy, a repair procedure is burdensome, and the storage, for example, in the mechanic's workshop, of the bulky battery system is difficult.

### SUMMARY

Large battery systems often suffer from structural problems due to their length and width. One hurdle in developing such battery systems is to ensure sufficient stability in a battery pack. Therefore, additional fastening means (e.g., fasteners), such as screw mounts, in the middle of the battery pack and extending through the battery pack may be provided. Such additional fastening means, however, may introduce potential places where water or other contaminants may enter the battery pack from the outside and cause safety issues. In other words, there might be a tightness or sealing problem.

According to embodiments of the present disclosure, a battery system is provided that exhibits sufficient stability while protecting the battery cells inside the battery system from water or other contaminants.

The present disclosure is defined by the appended claims and their equivalents. The description that follows is subject to this limitation. Any disclosure lying outside the scope of said claims and their equivalents is intended for illustrative as well as comparative purposes.

According to an embodiment of the present disclosure, a battery system includes: a battery housing including a frame and a cover plate on the frame forming an accommodation chamber defined by the frame and the cover plate; a plurality of battery cells accommodated in the accommodation chamber, and an inlay element including a sleeve portion and a collar portion at one end of the sleeve portion and having a through-hole extending therethrough. A tunnel extends through the frame, is delimited from the accommodation space by a circumferential wall, and is configured to receive a fastener extending through the tunnel to fasten the battery system to a carrying structure of a vehicle. The sleeve portion extends into the tunnel of the frame, and the collar portion is outside of the tunnel and abuts a surface of the cover plate. The sleeve portion includes a sleeve seal extending around an outer surface of the sleeve portion for sealing the sleeve portion to an inner surface of the tunnel, and the collar portion includes a first collar seal at a side of the collar portion abutting the surface of the cover plate, extending around a periphery of an opening in the cover plate, and sealing the collar portion to the cover plate.

The collar portion may be outside of the cover plate abutting an outer surface of the cover plate such that the first collar seal extending around a periphery of the opening in the cover plate and seals the collar portion to the cover plate from the outer surface of the cover plate. The collar portion may press the cover plate against the frame.

The sleeve portion may be connected to the tunnel via a threaded connection.

The collar portion and the frame may have mounting holes aligned with each other and the opening in the cover plate. A mounting element may extend through the opening in the cover plate and the mounting holes into the frame mounting the cover plate and inlay element to the frame.

The collar portion and the frame may each have first mounting holes aligned with each other and with a first opening in the cover plate. A first mounting element may extend through the first opening in the cover plate and the first mounting holes into the frame. The collar portion and the frame may each have second mounting holes aligned with each other and with a second opening in the cover plate. A second mounting element may extend through the second opening in the cover plate and the second mounting holes into the frame. The first mounting holes and the first opening are space apart at a first distance from the tunnel in a first direction, and the second mounting holes and the second opening are spaced apart at a second distance from the tunnel in a second direction. The first collar seal extends around a periphery of both the first opening and the second opening in the cover plate and seals the collar portion to the cover plate.

The collar portion may be between the cover plate and the frame, and the collar portion may abut an inner surface of the cover plate such that the first collar seal extends around a periphery of the opening in the cover plate and seals the collar portion to the cover plate from the inner surface of the cover plate.

The collar portion may include a second collar seal at a side of the collar portion abutting the surface of the frame. The second collar seal may extend around a periphery of the mounting holes and seal the collar portion to the frame.

The cover plate may be a top cover plate or a bottom cover plate.

The frame may include a crossbeam which includes the tunnel and/or the mounting hole.

The sleeve seal may include one or more sealing rings.

The first collar seal may include a sprayed-on gasket.

Another embodiment of the present disclosure provides an electric vehicle including the battery system as described above.

Another embodiment of the present disclosure provides the electric vehicle including the carrying structure and the fastener extending through the tunnel of the frame of the battery system to fasten the battery system to the carrying structure.

Further aspects and features of the present disclosure can be learned from the following description.

### BRIEF DESCRIPTION OF THE DRAWINGS

Aspects and features of the present disclosure will become apparent to those of ordinary skill in the art by describing, in detail, embodiments thereof with reference to the attached drawings, in which:

FIG. 1 is a schematic perspective view of an inlay element of a battery system according to an embodiment.

FIG. 2 is a schematic cross-sectional view of a battery system with the inlay element shown in FIG. 1.

FIGS. 3A and 3B are schematic perspective views of an inlay element of a battery system according to another embodiment.

FIG. 4 is a schematic perspective view of a battery system with the inlay element shown in FIGS. 3A and 3B.

FIG. 5 is a schematic cross-sectional view of the battery system with the inlay element as shown in FIG. 4.

FIG. 6 is a schematic perspective view of a carrying structure of an electric vehicle.

FIG. 7 is a schematic cross-sectional view of the carrying structure shown in FIG. 6.

### DETAILED DESCRIPTION

Reference will now be made, in detail, to embodiments of the present disclosure, examples of which are illustrated in the accompanying drawings. Aspects and features of the embodiments, and implementation methods thereof, will be described with reference to the accompanying drawings. The present disclosure, however, may be embodied in various different forms and should not be construed as being limited to the embodiments illustrated herein. Rather, these embodiments are provided as examples so that this disclosure will be thorough and complete and will fully convey the aspects and features of the present disclosure to those skilled in the art.

Accordingly, processes, elements, and techniques that are not considered necessary for those having ordinary skill in the art to have a complete understanding of the aspects and features of the present disclosure may not be described or may be briefly described.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification and should not be interpreted in an idealized or overly formal sense unless expressly so defined herein.

According to an embodiment of the present disclosure, a battery system includes a battery housing including a frame and a cover plate, for example, at least one cover plate. The cover plate may be a top cover plate and/or a bottom cover plate. In some embodiments, two cover plates may be provided—one top cover plate and one bottom cover plate. The cover plate may be disposed on the frame. Inside the battery housing and, thus, inside an inner space formed between the frame and the cover plate(s), an accommodation chamber is defined which accommodates a plurality of battery cells. The accommodation chamber is defined by the frame and the cover plate. The battery system includes a plurality of battery cells, for example, prismatic, pouch, or cylindrical battery cells. The battery cells may be arranged to form one or more battery packs.

The frame of the battery system forms a part of a carrier framework of the battery system. The cover plate may also form a part of this carrier framework. The carrier framework carries and/or supports the battery cells. The carrier framework provides a structural connection to a carrying structure of a vehicle in which the battery system may be mounted/installed. In other words, the frame may be an integral structure of the battery housing, which provides structural rigidity to the battery housing. The frame may include beams extending in a horizontal and/or vertical plane and rigidly joined support elements to support the cover plate of the battery housing.

A tunnel, or passage, extends through the frame and through the accommodation chamber inside the frame. The tunnel extends from a first (e.g., lower) end of the accommodation chamber to a second (e.g., upper) end of the accommodation chamber. In other words, the tunnel has a first opening at a first end surface of the frame and extends from the first opening through the frame up to a second opening at a second end surface of the frame. The tunnel has a circumferential wall that delimits the tunnel from the accommodation chamber. The tunnel thereby provides (or forms) a sealed passage. In other words, the frame includes a (vertical) beam extending through the accommodation chamber and connecting a first side of the frame with a second side of the frame, and the tunnel is formed inside the beam. The tunnel is configured to receive a fastening element (e.g., a fastener) to fasten the battery system to the carrying structure of the vehicle. That is, the tunnel is formed or configured to accommodate the fastening element, for example, a screw or bolt, extending through the tunnel. For example, a cross-section or diameter of the tunnel may correspond to a cross-section or diameter of the fastening element. The fastening element may fasten the frame and, thus, the battery system, to the carrying structure of the vehicle.

The battery system further includes an inlay element, which is arranged partially inside the tunnel. The inlay element includes a sleeve portion and a collar portion, and the collar portion is disposed at one end of the sleeve portion. The sleeve portion is the part of the inlay element arranged inside the tunnel. In other words, the inlay element is disposed at the frame with its sleeve portion extending into the tunnel of the frame. The collar portion is disposed outside of the tunnel and abuts a surface of the cover plate. The collar portion may abut an outer surface of the frame extending around (or surrounding) the tunnel entrance as well or may press the cover plate onto the frame as explained below. A through-hole extends through the inlay element. That is, the through-hole extends through both the collar portion and the sleeve portion. The through-hole is configured to receive the fastening element to fasten the battery system to the carrying structure of the vehicle. The inner surface of the tunnel may have a recess in which the sleeve portion of the inlay element may be received. The cross-section of the through-hole of the inlay element may correspond to or be substantially the same as the cross-section of the tunnel. The inlay element thus forms a bushing or socket for the fastening element.

The sleeve portion includes a sleeve seal encircling (or extending around) an outer surface of the sleeve portion. For example, the sleeve seal may include one or more sealing rings, for example, O-rings. When two or more sealing rings are provided, they may be distanced (or spaced) from each other in an axial direction of the sleeve portion for redundancy. The sleeve seal seals the sleeve portion and, thus, the inlay element, to an inner surface of the tunnel. That is, the sleeve seal prevents water or other contaminants from entering between, or seeping in, the outer surface of the sleeve portion of the inlay element and the inner surface of the tunnel thereby preventing water or other contaminants from entering the battery housing and the accommodation chamber.

The collar portion includes a first collar seal, which is disposed at a side of the collar portion abutting the surface of the cover plate. As mentioned above, the collar portion of the inlay element abuts with one side thereof the cover plate. The first collar seal of the collar portion is arranged at this side of the collar portion. The first collar seal is disposed such that it surrounds (or extends around a periphery of) an opening in the cover plate to seal the collar portion to the cover plate. That is, the cover plate has an opening. The opening in the cover plate may be aligned with the tunnel of the frame and may, in conjunction with the tunnel and the through-hole in the inlay element, form part of the passage through the accommodation chamber. In another embodiment, the opening in the cover plate may be a mounting opening via which the cover plate may be fastened to the frame at a different position than the tunnel, as explained below. The first collar seals the collar portion and, thus, the inlay element, to a surface of the cover plate. That is, the first collar seal prevents water or other contaminants from entering between, or seeping in, the collar portion and the cover plate thereby preventing water or other contaminants from entering the battery housing and the accommodation chamber.

The battery system, according to an embodiment of the present disclosure, includes an inlay element that provides a dual-sealing structure: a first sealing (or first seal) via the sleeve seal that prevents water or other contaminants from entering the accommodation chamber via the tunnel; and a second sealing (or second seal) via the first collar seal that prevents water or other contaminants from entering the accommodation chamber via the cover plate. Thus, the battery system may be fastened to the carrying structure of a vehicle via a fastening element extending through the tunnel while providing protection for the battery cells. That is, the battery system according to embodiments of the present disclosure, via the inlay element, prevents water or other external or environmental influences from entering the battery pack and causing safety issues. Thus, the battery system according to embodiments of the present disclosure provides sufficient stability of the battery system due to the tunnel configured to receive the fastening element, while protecting the battery cells inside the battery system from external or environmental influences via the inlay element with its dual-sealing structure. In other words, embodiments of the present disclosure provide an inlay element with sealings, for example, the first collar seal and the sleeve seal, and without the necessity of pre-coated fine-threads, to ensure a tight battery pack despite the use of screws extending through the battery, which may be necessary to securely mount a large battery pack.

The inlay element may additionally act as a tolerance compensator. For example, the connection between the cover plate and the frame, for example, between the bottom cover, the frame, and the top cover (when both covers are provided) may be prone to large tolerances, and therefore, the tightness problem may be larger issue. The inlay element may overcome this issue because it acts as an adaptor or compensator, which widens the surface at where the battery system can be sealed and ensures a closed-off accommodation chamber despite the tunnel.

According to an embodiment, the collar portion is disposed outside of the cover plate abutting an outer surface of the cover plate such that the first collar seal surrounds the opening in the cover plate and seals the collar portion to the cover plate from the outer surface of the cover plate. The collar portion presses the cover plate against the frame. The collar portion being disposed outside of the cover plate means that (a section of) the cover plate extends in-between the collar portion and the frame. In this embodiment, the surface of the cover plate which the collar portion of the inlay element abuts is an outer surface of the cover plate, that is, the surface facing away from the frame. In this embodiment, the opening in the cover plate may be aligned with the tunnel and may, in conjunction with the tunnel and the through-hole in the inlay element, form the passage through the accommodation chamber. The inlay element may have rotational symmetry with a symmetry axis extending centrally through the through-hole. Thus, in this embodiment, the first collar seal seals the collar portion to the cover plate from the outer surface of the cover plate. The collar portion is pressed against cover plate and, thus, presses the cover plate, which is disposed between the frame and the cover plate, against the frame. Fastening means (e.g., a fastener) may be provided to achieve this pressing. Thereby, the first collar seal may prevent water or other contaminants from entering between the outer surface of the cover plate and the collar portion and, thus, from entering the accommodation chamber and reaching the battery cells. Such an inlay element may provide for simple and efficient sealing.

Simple and efficient sealing may be achieved when the opening in the cover plate is aligned with the tunnel and the inlay element is inserted with the sleeve portion into the tunnel and the collar portion abutting the outer surface of the cover plate. According to an embodiment, the sleeve portion is connected to the tunnel via a threaded connection. For example, the sleeve portion may have an external thread screwed into an internal thread of the frame, for example, into an internal thread of the tunnel. That is, the tunnel may have an internal thread, and the sleeve portion of the inlay element may have an external thread. The inlay element may be screwed, via the sleeve portion, into the tunnel of the frame, thereby fastening the inlay element and the cover plate, which is disposed between the frame and the cover plate, to the frame. This allows for simple and efficient mounting of the inlay element and, at the same time, the cover plate to the frame. Thus, additional fastening means or screws may be omitted.

According to an embodiment, the collar portion and the frame have mounting holes aligned with each other and the opening in the cover plate. A mounting element extends through the opening in the cover plate and the mounting holes into the frame mounting the cover plate and inlay element to the frame. That is, each of the collar portion and frame has a mounting hole aligned with, or overlapping, the opening in the cover plate. In other words, the frame may have a first mounting hole, and the collar portion may have a second mounting hole. The first mounting hole, the second mounting hole, and the opening in the cover plate are aligned with each other. The mounting holes and opening are aligned with each other such that a mounting element, such as a screw or bolt, can be inserted through the opening in the cover plate, through the mounting hole in the collar portion, and into the mounting hole in the frame. Thereby, the cover plate and inlay element are mounted, or fastened, to the frame. The mounting hole of the frame may have an internal thread, and the mounting element, for example, a screw, may have an external thread so that the mounting element may be screwed into the mounting hole in the frame. In one embodiment, the opening in the cover plate is not aligned with the tunnel but rather forms a mounting opening via which the cover plate may be mounted, or fastened, to the frame at a different position than the tunnel. Such an embodiment may provide an inlay element that is securely fastened to the frame while providing sufficient sealing against water and other contaminants. Even if water or contaminants were to enter along the mounting element through the opening in the cover plate, the path in-between the cover plate and the collar portion into the accommodation chamber is blocked.

The battery system may include multiple of such mounting means, for example, two. For example, the frame may have multiple mounting holes, for example, at opposite sides from the tunnel. The collar portion of the inlay element may have two corresponding mounting holes, each aligned with one of the mounting holes in the frame. Correspondingly, the cover plate may have two openings, each aligned with one of the mounting holes in the frame and of the collar portion. That is, according to an embodiment, the collar portion and the frame each has first mounting holes aligned with each other and with a first opening in the cover plate. A first mounting element extends through the first opening in the cover plate and the first mounting holes into the frame. The collar portion and the frame each have second mounting holes aligned with each other and with a second opening in the cover plate, and a second mounting element extends through the second opening in the cover plate and the second mounting holes into the frame. The first mounting holes and the first opening are disposed at (or spaced apart by) a first distance from the tunnel in a first direction, and the second mounting holes and the second opening are disposed at a second distance from the tunnel in a second direction. The first collar seal surrounds both the first opening and the second opening in the cover plate and seals the collar portion to the cover plate. The first distance may be the same as the second distance. The first direction may be different than the second direction, in particular, opposite thereto. In other words, the frame may have two mounting holes at its surface on different sides of the tunnel. The collar portion may have corresponding openings, and the cover plate may have corresponding mounting holes. Mounting the cover plate onto the frame on two opposite sides of the tunnel may provide improved structural stability. The first collar seal, in this embodiment, is disposed such that it surrounds both the openings in the cover plate, that is, both the first opening and the second opening in the cover plate. The first collar seal may provide secure sealing preventing water or other contaminants from entering the accommodation chamber from in between the cover plate and the collar portion of the inlay element.

According to an embodiment, the collar portion is disposed inside of the cover plate between the cover plate and the frame. The collar portion abuts an inner surface of the cover plate such that the first collar seal surrounds the opening in the cover plate and seals the collar portion to the cover plate from the inner surface of the cover plate. The cover plate and the collar portion (and, thus, the inlay element) are mounted to the frame via the above-explained one or more mounting elements extending through the one or more mounting holes and openings. The one or more mounting elements may press the cover plate onto the collar portion and both the cover plate and the collar portion onto the frame.

According to an embodiment, the collar portion includes a second collar seal at a side of the collar portion abutting the surface of the frame. The second collar seal surrounds the mounting holes and seals the collar portion to the frame. Thus, in this embodiment, the collar portion of the inlay element includes two collar seals, one at each surface. In other words, the collar portion includes the first collar seal on the surface of the collar portion that faces the cover plate and the second collar seal on the surface of the collar portion that faces the frame. Here, the collar portion is disposed between the cover plate and the frame. The second collar seal also seals a possible path between the frame and the collar portion. That is, even if water or contaminants were to enter along the mounting element through the opening in the cover plate and the mounting hole of the collar portion, the path in-between the collar portion and the frame into the accommodation chamber by the second collar seal is blocked.

According to an embodiment, the cover plate is a top cover plate and/or a bottom cover plate. As mentioned above, the cover plate may be either a top cover plate or a bottom cover plate. The battery housing may include both a top cover plate and a bottom cover plate. The embodiments disclosed herein apply to both the top cover plate and the bottom cover plate if both are present.

According to an embodiment, the frame includes a crossbeam which includes the tunnel and/or the mounting hole. That is, the tunnel may be formed in/through the crossbeam, and the crossbeam may extend through the accommodation chamber. Also, the one or more mounting holes for mounting the inlay element to the frame may be disposed inside the crossbeam. The collar portion of the inlay element may expand over the edges of the crossbeam such that a sealing surface or the first collar seal is broader than the crossbeam. Thereby, the tunnel opening of the frame, which may be relatively wide compared to the relatively narrow width of the crossbeam, can be sealed without having to broaden the crossbeam, which would reduce the energy density of the battery pack.

According to an embodiment, the sleeve seal includes one or more sealing rings. As mentioned above, the sleeve seal may include one or more O-rings. When two or more sealing rings are provided, they may be distanced in (or spaced apart from each other in) an axial direction of the sleeve portion for redundancy. This provides secure sealing between the inner surface of the tunnel and the outer surface of the sleeve portion.

According to an embodiment, the first collar seal includes (or consists of) a spray-on gasket. In other words, the first collar seal may be formed via spray-on or may be sprayed-on. Spraying on the first collar seal may be a simple way of providing the first collar seal. The second collar seal, if present, may be provided in the same manner.

Embodiments of the present disclosure also provide an electric vehicle including a battery system as described above.

According to an embodiment, the electric vehicle further includes a carrying structure and a fastening element (or fastener). The fastening element extends through the tunnel of the frame of the battery system to fasten the battery system to the carrying structure. The fastening element thereby also extends through the through-hole of the inlay element. The battery system may, thus, be securely fastened to the carrying structure while maintaining a secure seal protecting the battery cells from water or other contaminants.

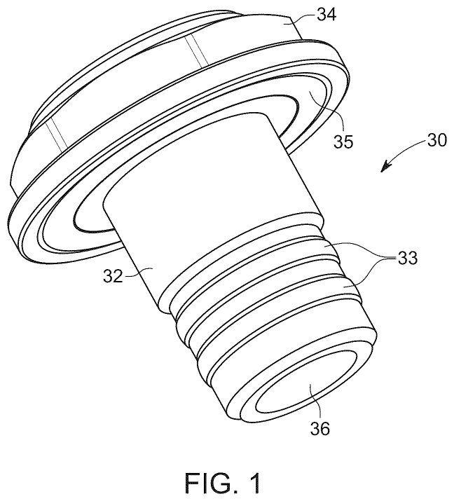

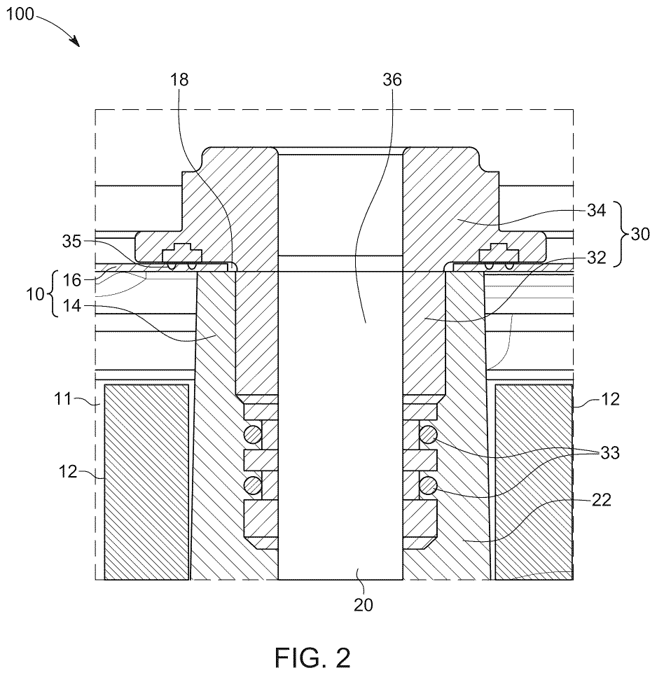

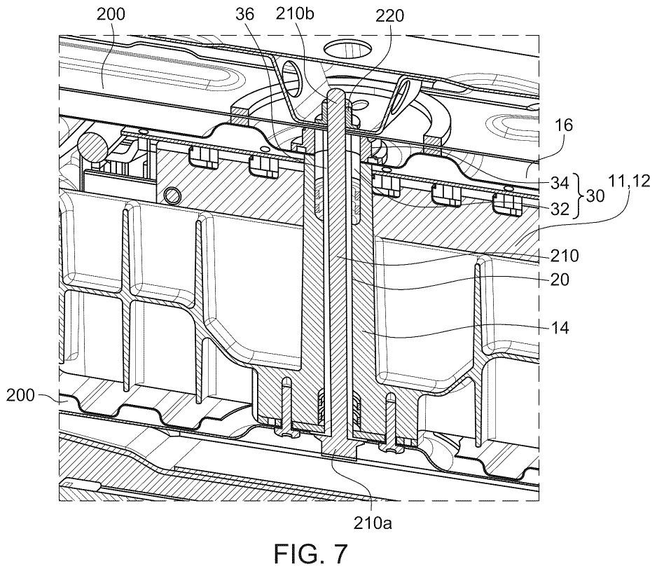

FIGS. 1 and 2 illustrate aspects of a battery system 100 according to an embodiment of the present disclosure. FIG. 1 is a schematic perspective view of an inlay element 30 of the battery system 100, and FIG. 2 shows a part of the battery system 100 including the inlay element 30 in a cross-sectional view. The battery system 100 includes a battery housing 10 enclosing (or forming) an accommodation chamber 11 inside of which a plurality of battery cells 12 are arranged. The battery housing 10 includes a frame 14 and a cover plate 16 disposed on the frame 14, and the accommodation chamber 11 is defined by (or is defined between) the frame 14 and the cover plate 16. The cover plate 16 may be a top cover plate. The frame 14 forms part of a carrier framework of the battery system 100 via which the battery system 100 may be fastened to a carrying structure 200 of an electric vehicle (see, e.g., FIG. 7).

The frame 14 includes a tunnel 20 extending through the frame 14 from an upper end of the battery system 100 to a lower end of the battery system 100. The part of the frame 14 including the tunnel 20 may be a (cross)beam, which may separate neighboring battery cells 12. The tunnel 20 extends completely through the battery system 100 and, thus, also extends entirely through the accommodation chamber 11, that is, from a first end to a second end of the accommodation chamber 11. The tunnel 20 is delimited from the accommodation chamber 11 via a circumferential wall 22 of the tunnel 20.

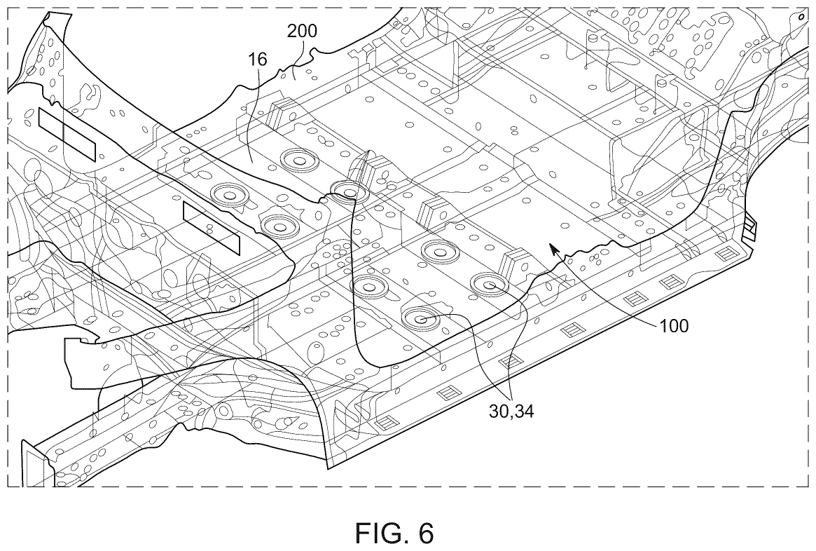

The tunnel 20 is configured to receive a fastening element (e.g., a fastener) 210, which may extend through the tunnel 20 to fasten the battery system 100 to the carrying structure 200 of the electric vehicle (see, e.g., FIG. 7). FIG. 6 illustrates a schematic perspective view of the carrying structure 200 of the electric vehicle and of the battery system 100 disposed therein, and FIG. 7 shows a cross-sectional view through the carrying structure 200 shown in FIG. 6 and through the battery system 100 disposed therein. In the illustrated embodiment, the fastening element 210 extends through the tunnel 20, and at the bottom end of the tunnel 20, a head 210a of the fastening element 210 abuts against a lower part of the carrying structure 200 and, at the top end of the tunnel 20, an end 210b of the fastening element 210 is fastened to an upper part of the carrying structure 200 via a nut 220. Thereby, the battery system 100 is fastened/fixed to the carrying structure 200.

The battery system 100 further includes an inlay element 30, an embodiment of which is shown in a perspective view in FIG. 1. The inlay element 30 includes a sleeve portion 32 and a collar portion 34 at an end of the sleeve portion 32. A through-hole 36 extends through the inlay element 30, that is, through both the sleeve portion 32 and the collar portion 34 as shown in, for example, FIG. 2. In the assembled state of the battery system 100, the inlay element 30 is disposed at the frame 14 with its sleeve portion 32 extending into the tunnel 20 of the frame 14 and the collar portion 34 outside of the tunnel 20 and abutting an outer surface of the cover plate 16.

The sleeve portion 32 includes a sleeve seal 33 encircling (or extending around) an outer surface of the sleeve portion 32 for sealing the sleeve portion 32 to an inner surface of the tunnel 20. The sleeve seal 33 may include two sealing rings distanced in (e.g., spaced apart from each other in) an axial direction of the sleeve portion 32 as shown in, for example, FIG. 2. The collar portion 34 includes a first collar seal 35 at a side of the collar portion 34 abutting the outer surface of the cover plate 16. The first collar seal 35 surrounds (e.g., extends around a periphery of) an opening 18 in the cover plate 16 and seals the collar portion 34 to the cover plate 16.

The inlay element 30 may, via the collar portion 34, press the cover plate 16 against the frame 14. This may be achieved, for example, via a threaded connection between the sleeve portion 32 and the tunnel 20. For example, the sleeve portion 32 may have an external thread screwed into an internal thread of the tunnel 20.

The inlay element 30 provides the battery system 100 with a dual-sealing structure. For example, a first sealing (or a first seal) is provided via the sleeve seal 33, which prevents water or other contaminants from entering the accommodation chamber 11 from the tunnel 20 by flowing in-between the outer surface of the sleeve portion 32 and the inner surface of the tunnel 20. Further, a second sealing (or a second seal) is provided via the first collar seal 35, which prevents water or other contaminants from entering the accommodation chamber 11 by flowing in-between the collar portion 34 and the cover plate 16. Thus, the tunnel 20 provides a fastening means (e.g., a fastener) for fastening the battery system 100 to the carrying structure 200 of the vehicle via the fastening element 210 extending through the tunnel 20 while the inlay element 30 ensures protection of the battery cells 12 from water or contaminants.

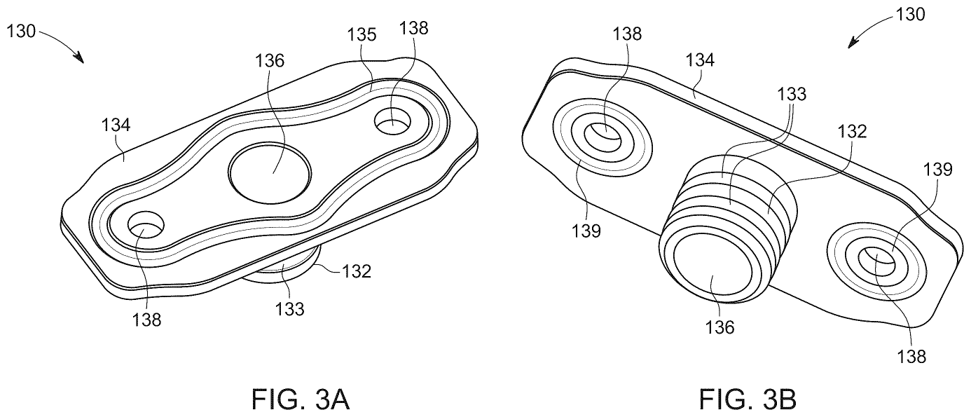

Another embodiment of a battery system 100 is shown in FIGS. 3A-5. The battery system 100 shown in FIGS. 3A-5 includes an inlay element 130 that differs from the inlay element 30 described above.

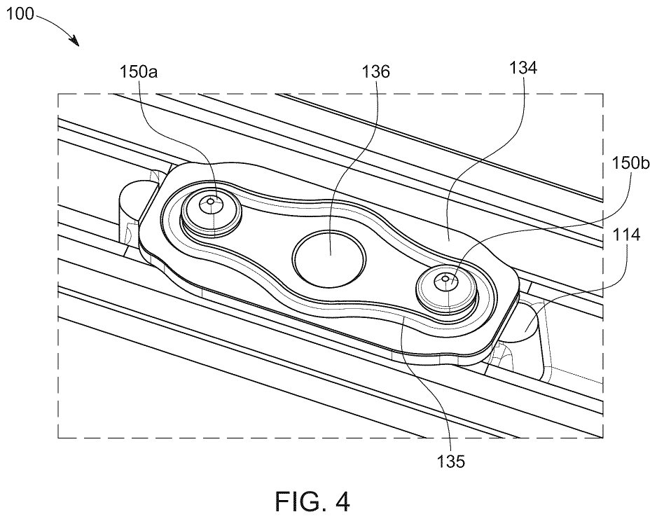

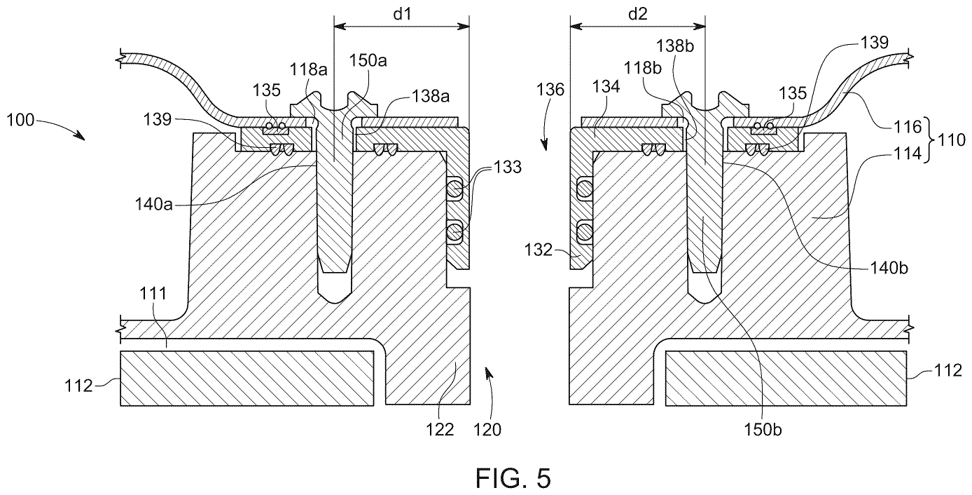

The inlay element 130 is shown in FIG. 3A in a perspective top view and in FIG. 3B in a perspective bottom view. FIG. 4 shows the inlay element 130 mounted in the battery system 100 without showing (omitting) the cover plate. FIG. 5 shows a part of the battery system 100 in a cross-sectional view with the cover plate.

The battery system 100 includes a battery housing 110 enclosing (or forming) an accommodation chamber 111 inside of which a plurality of battery cells 12 are arranged. The battery housing 110 includes a frame 114 and a cover plate 116 disposed on the frame 114. The cover plate 116 may be a bottom cover plate. The frame 114 forms a part of a carrier framework of the battery system 100 via which the battery system 100 may be fastened to the carrying structure 200 of the electric vehicle, as explained above.

The frame 114 includes a tunnel 120 extending through the frame 114 from an upper end of the battery system 100 to a lower end of the battery system 100. The part of the frame 114 including the tunnel 120 may be a crossbeam, which may separate neighboring battery cells 112. The tunnel 120 extends completely through the battery system 100 and, thus, also extends completely through the accommodation chamber 111, that is, from a first end to a second end of the accommodation chamber 111. The tunnel 120 is delimited from the accommodation chamber 111 via a circumferential wall 122 of the tunnel 120. The tunnel 120 is configured to receive the fastening element 210, which may extend through the tunnel 120 to fasten the battery system 100 to the carrying structure 200 of the electric vehicle, as explained above.

The inlay element 130 includes a sleeve portion 132 and a collar portion 134 at an end of the sleeve portion 132. A through-hole 136 extends through the inlay element 130, that is, through both the sleeve portion 132 and the collar portion 134 as shown in, for example, FIGS. 3A and 3B. In the assembled state of the battery system 100, the inlay element 130 is disposed at the frame 114 with its sleeve portion 132 extending into the tunnel 120 of the frame 114 and the collar portion 134 outside of the tunnel 120 and abutting an inner surface of the cover plate 116.

The sleeve portion 132 includes a sleeve seal 133 encircling (e.g., extending around) an outer surface of the sleeve portion 132 for sealing the sleeve portion 132 to an inner surface of the tunnel 120. The sleeve seal 133 may include two sealing rings distanced in (e.g., spaced apart from each other in) an axial direction of the sleeve portion 132, as shown in, for example, FIGS. 3B and 5.

The collar portion 134 includes a first collar seal 135 at a side of the collar portion 134 abutting the inner surface of the cover plate 16. Different from the inlay element 30 described above with reference to FIGS. 1 and 2, the collar portion 134 of the inlay element 130 is placed between the cover plate 116 and the frame 114. In the embodiment described above with reference to FIGS. 1 and 2, the cover plate 16 is placed between the collar portion 34 and the frame 14. Therefore, the first collar seal 135 of the inlay element 130 is disposed on the upper surface of the inlay element 130. In the embodiment described above with reference to FIGS. 1 and 2, the first collar seal 35 is disposed on the lower surface of the inlay element 30. The first collar seal 135 surrounds (e.g., extends around a periphery of) two openings 118a, 118b in the cover plate 116 and seals the collar portion 134 to the cover plate 116.

The collar portion 134 and the frame 114 each include first mounting holes (or first mounting openings) 138a, 140a aligned with each other and with a first opening 118a in the cover plate 116. A first mounting element 150a extends through the first opening 118a in the cover plate 116 and the first mounting holes 138a, 140a into the frame 114. The collar portion 134 and the frame 114 each further include second mounting holes (or second mounting openings) 138b, 140b aligned with each other and with a second opening 118b in the cover plate 116. A second mounting element 150b extends through the second opening 118b in the cover plate 116 and the second mounting holes 138b, 140b into the frame 114. The first mounting holes 138a, 140a and the first opening 118a are disposed at a first distance d₁ from the tunnel 120 in a first direction, and the second mounting holes 138b, 140b and the second opening 118b are disposed at a second distance d₂ from the tunnel 120 in a second direction opposite the first direction as shown in, for example, FIG. 5. The first collar seal 135 surrounds (e.g., extends around a periphery of) both the first opening 118a and the second opening 118b in the cover plate 116 and seal the collar portion 134 to the cover plate 116.

The first and second mounting elements 150a, 150b may be connected to their respective first and second mounting holes 140a, 140b via, for example, threaded connections. For example, the first and second mounting elements 150a, 150b may each have an external thread and, thus, may be screwed into an internal thread of the first and second mounting holes 140a, 140b, respectively. Thereby, the first and second mounting elements 150a, 150b may press the cover plate 116 and the collar portion 134 against the frame 114.

Furthermore, the inlay element 130 includes two second collar seals 139 at a surface of the collar portion 134 abutting the surface of the frame 114, that is, at the lower surface of the collar portion 134. The second collar seals 139 surround (e.g., extend around a periphery of) the first and second mounting holes 140a, 140b in the frame 114 (and the first and second mounting holes 138a, 138b in the collar portion 134) and seal the collar portion 134 to the frame 114.

Similar to the inlay element 30 described above with reference to FIGS. 1 and 2, the inlay element 130 provides the battery system 100 with a dual-sealing structure. For example, a first sealing (or a first seal) is provided via the sleeve seal 133, which prevents water or other contaminants from entering the accommodation chamber 111 from the tunnel 120 by flowing in-between the outer surface of the sleeve portion 132 and the inner surface of the tunnel 120. Further, a second sealing (or a second seal) is provided via the first collar seal 135, which prevents water or other contaminants from entering the accommodation chamber 111 by flowing in-between the collar portion 134 and the cover plate 116. Thus, the tunnel 120 provides a fastening means (e.g., a fastener) for fastening the battery system to the carrying structure 200 of the vehicle via the fastening element 210 extending through the tunnel 120 while the inlay element 130 ensures protection of the battery cells 112 from water or contaminants.

Further, the inlay element 130 provides a triple-sealing via the second collar seals 139, which prevent water or other contaminants from entering the accommodation chamber 111 by flowing from the cover plate 116 through the openings 118a, 118b and the mounting holes 138a, 138b and in-between the lower surface of the collar portion 134 and the upper surface of the frame 114.

Therefore, the battery systems according to embodiments of the present disclosure, via their inlay element, prevent water or other external or environmental influences from entering the battery system and causing safety issues. In other words, embodiments of the present disclosure provide an inlay element with sealings, for example, the first collar seal and the sleeve seal, without the necessity of pre-coated fine-threads to ensure a tight battery pack despite the use of fastening elements extending through the battery system, which may be necessary in a large battery pack.

### SOME REFERENCE SYMBOLS

10 battery housing
11 accommodation chamber
12 battery cells
14 frame
16 cover plate
18 opening in cover plate
20 tunnel
22 circumferential wall of tunnel
30 inlay element
32 sleeve portion
33 sleeve seal
34 collar portion
35 first collar seal
36 through-hole
100 battery system
110 battery housing
111 accommodation chamber
112 battery cells
114 frame
116 cover plate
118a first opening in cover plate
118b second opening in cover plate
120 tunnel
122 circumferential wall of tunnel
130 inlay element
132 sleeve portion
133 sleeve seal
134 collar portion
135 first collar seal
138a first mounting hole
138b second mounting hole
139 second collar seal(s)
136 through-hole
140a first mounting hole
140b second mounting hole
150a first mounting element
150b second mounting element
200 carrying structure
210 fastening element
210a head of fastening element
210b end of fastening element
220 nut

What is claimed is:

1. A battery system comprising:
a battery housing comprising a frame and a cover plate on the frame and forming an accommodation chamber therebetween, a tunnel delimited from the accommodation chamber by a circumferential wall extends through the frame, the tunnel is configured to receive a fastener extending through the tunnel to fasten the battery system to a carrying structure of a vehicle;
a plurality of battery cells accommodated in the accommodation chamber; and
an inlay element comprising a sleeve portion and a collar portion at one end of the sleeve portion, a through-hole extending through the inlay element,
wherein the inlay element is at the frame with its sleeve portion extending into the tunnel of the frame and the collar portion being outside of the tunnel and abutting a surface of the cover plate,
wherein the sleeve portion comprises a sleeve seal extending around an outer surface of the sleeve portion and sealing the sleeve portion to an inner surface of the tunnel, and
wherein the collar portion comprises a first collar seal at a side of the collar portion abutting the surface of the cover plate, the first collar seal extending around a periphery of an opening in the cover plate and sealing the collar portion to the cover plate.

2. The battery system as claimed in claim 1, wherein the collar portion is outside of the cover plate abutting an outer surface of the cover plate such that the first collar seal extends around a periphery of the opening in the cover plate and seals the collar portion to the cover plate from the outer surface of the cover plate, and
wherein the collar portion presses the cover plate against the frame.

3. The battery system as claimed in claim 1, wherein the sleeve portion is connected to the tunnel via a threaded connection.

4. The battery system as claimed in claim 1, wherein the collar portion and the frame each have mounting holes aligned with each other and the opening in the cover plate, and
wherein a mounting element extends through the opening in the cover plate and the mounting holes into the frame mounting the cover plate and inlay element to the frame.

5. The battery system as claimed in claim 4, further comprising a first mounting element and a second mounting element,
wherein the collar portion and the frame each have first mounting holes aligned with each other and with a first opening in the cover plate,
wherein the first mounting element extends through the first opening in the cover plate and the first mounting holes into the frame,
wherein the collar portion and the frame each have second mounting holes aligned with each other and with a second opening in the cover plate,
wherein the second mounting element extends through the second opening in the cover plate and the second mounting holes into the frame,
wherein the first mounting holes and the first opening are spaced apart by a first distance from the tunnel in a first direction, and the second mounting holes and the second opening are spaced apart by a second distance from the tunnel in a second direction, and
wherein the first collar seal extends around a periphery of both the first opening and the second opening in the cover plate and seals the collar portion to the cover plate.

6. The battery system as claimed in claim 4, wherein the collar portion is between the cover plate and the frame, the collar portion abutting an inner surface of the cover plate such that the first collar seal extends around a periphery of the opening in the cover plate and seals the collar portion to the cover plate from the inner surface of the cover plate.

7. The battery system as claimed in claim 6, wherein the collar portion comprises a second collar seal at a side of the collar portion abutting the surface of the frame, the second collar seal extending around a periphery of the mounting holes and sealing the collar portion to the frame.

8. The battery system as claimed in claim 4, wherein the frame comprises a crossbeam in which the mounting holes are formed.

9. The battery system as claimed in claim 1, wherein the cover plate is a top cover plate or a bottom cover plate.

10. The battery system as claimed in claim 1, wherein the frame comprises a crossbeam in which the tunnel is formed.

11. The battery system as claimed in claim 1, wherein the sleeve seal comprises one or more sealing rings.

12. The battery system as claimed in claim 1, wherein the first collar seal comprises a sprayed-on gasket.

13. An electric vehicle comprising the battery system as claimed in claim 1.

14. The electric vehicle as claimed in claim 13, further comprising the carrying structure and the fastener extending through the tunnel of the frame of the battery system to fasten the battery system to the carrying structure.
